(19) United States
(12) Patent Application Publication
(10) Pub. No.: US 2024/0388024 A1
(43) Pub. Date: Nov. 21, 2024

(54) BOARD CONNECTOR AND BOARD-TO-BOARD CONNECTOR

(71) Applicant: Molex, LLC, Lisle, IL (US)

(72) Inventors: Masato Kawabata, Yamato (JP); Mikiji Tanaka, Yamato (JP)

(21) Appl. No.: 18/704,073

(22) PCT Filed: Dec. 13, 2022
(86) PCT No.: PCT/IB2022/062101

§ 371 Date: Apr. 24, 2024

(30) Foreign Application Priority Data
Dec. 22, 2021 (JP) 2021-207793

(51) Int. Cl. H01R 12/73; H01R 12/72

(52) U.S. Cl. CPC H01R 12/737; H01R 12/722

(57) ABSTRACT

A board connector, including: housing; and a signal terminal mounted in this housing; wherein the housing includes a first space portion and a second space portion positioned further in the anti-mating direction than the first space portion, and a first side surface of the signal terminal is exposed to the outside of the board connector through the first space portion and the second space portion, and the housing further includes a third space portion and this third space portion is positioned on a second side surface of the signal terminal and the signal terminal engages with the third space portion.

### RELATED APPLICATIONS

This application claims priority to Japanese Patent application no. 2021-207793, filed Dec. 22, 2021, which is incorporated herein by reference in their entirety.

### TECHNICAL FIELD

The present disclosure relates to a board connector and a board-to-board connector.

### BACKGROUND ART

Conventionally, board-to-board connectors have been used to electrically connect pairs of circuit boards to each other. However, in recent years, as the speed of electric signals transmitted between circuit boards has increased, there is demand for matching the impedance of electrical signal transmission lines even in board-to-board connectors. Herein, a proposal has been given to curve a part of the terminal that is the electrical signal transmission path to partially change the pitch of the terminal for impedance matching (for example, see Patent Document 1).

FIG. 18 is a partial plan view illustrating a pitch conversion section of a terminal for a conventional connector.

In the figure, 861 is for terminals of the connector (not shown) that are lined up in the width direction of the connector and for convenience of description are imparted the codes 861a, 861b . . . 861h, in order from the left side of the figure. Furthermore, each of the terminals 861 include a contact part 865 that contacts a terminal of the counterpart connector (not shown), a support section 862 that is supported in a housing (not shown) of the connector, and a tail section 863 that is soldered to a pad on a board (not shown).

In addition, the mutually adjacent terminal 861c and terminal 861d with the code S attached function as signal terminals and, for example, if transmitting a differential signal, one signal is positive and an other signal is negative. Furthermore, terminal 861b and terminal 861e with the code G attached function as ground terminals. Note that in the figure, the codes S and G are omitted but the terminal 861a, terminal 861f, and terminal 861g function as signal terminals and the terminal 861h functions as a ground terminal.

Furthermore, the terminals 861 are provided with a pitch conversion section 864. In this pitch conversion section 864, terminal 861a, terminal 861c, terminal 861d, terminal 861f, and terminal 861g that function as signal terminals are bent at an incline in the pitch direction of the terminals 861 (lateral direction in the figure). As a result, in the contact part 865, the pitch between the adjacent signal terminals, that is, the distance between the terminal 861c and the terminal 861d and the distance between the terminal 861f and the terminal 861g are widened while the pitch between mutually adjacent signal terminals and ground terminals, in other words, the distance between terminal 861a and terminal 861b, the distance between terminal 861b and terminal 861c, the distance between terminal 861d and terminal 861e, the distance between terminal 861e and terminal 861f, and the distance between terminal 861g and terminal 861h is narrowed. Thereby, the impedance of the terminals 861 can be adjusted and matched.

Prior Art Documents: Patent Documents: Patent Document 1: Japanese Unexamined Patent Application 2005-149770

### SUMMARY

However, impedance of a conventional connector is adjusted by bending the terminals 861 in the pitch direction and this reduces the mechanical properties and manufacturability of the terminals 861, which in turn reduce the mechanical properties and manufacturability of the connector. In addition, the size of connectors has been reduced in conjunction with reduction in size of electronic devices and electronic components requiring extreme miniaturizing of the dimensions and pitch of the various parts of the terminals 861 and under these circumstances, bending the terminals 861 in the pitch direction is difficult.

Here, an object is to provide a highly reliable board connector and board-to-board connector that resolves the conventional problems and enables suitable adjustment of terminal impedance.

A board connector, including:
housing; and a signal terminal mounted in this housing; wherein
the housing includes a first space portion and a second space portion positioned further in the anti-mating direction than the first space portion, and a first side surface of the signal terminal is exposed to the outside of the board connector through the first space portion and the second space portion, and
the housing further includes a third space portion and this third space portion is positioned on a second side surface of the signal terminal and the signal terminal engages with the third space portion.

With another board connector, the dimension of the first space portion in the mating direction is larger than that of the second space portion.

With yet another board connector, when the board connector and counterpart connector are in a mated state, at least a part of the first space portion is covered by the counterpart connector.

With yet another board connector, the housing further includes:
a recessed section for stowing at least a portion of the counterpart connector and that is open on the mating direction end,
a long wall section that demarcates at least a portion of the side surface of the recessed section, and
a bottom plate that closes the anti-mating direction end of the recessed section, and
the second space portion is formed in the long wall section, overlapping with the bottom plate in the mating direction.

With yet another board connector, the second space portion and third space portion are formed mutually adjacent with respect to the mating direction.

With yet another board connector, the dimensions of the first space portion and the second space portion in the width direction are smaller than the dimension of the signal terminal in the width direction.

With yet another board connector, the portion of the signal terminal corresponding to the first space portion with respect to the mating direction can function as a contact area with the counterpart signal terminal of the counterpart connector.

With yet another board connector, there are a plurality of signal terminals forming at least two mutually parallel rows with the first space portion, second space portion, and third space portion positioned on the side surface of the signal terminals of each row symmetrically formed to face each other.

With yet another board connector, gold plating is performed on the side surface of the signal terminal exposed to the outside of the board connector through the first space portion and the second space portion.

A board-to-board connector includes the board connector of the present disclosure and a counterpart connector that mates with this board connector.

According to the present disclosure, the board connector can appropriately adjust the impedance of the terminals. In addition, the size can be reduced, the structure is simple, the number of components is low, manufacturing is simple, cost can be reduced, and reliability is high.

### BRIEF DESCRIPTION OF THE DRAWINGS

FIG. 1 is a perspective view illustrating the first connector and the second connector of the present embodiment in a meshed state.

FIG. 2 is a front view illustrating the first connector and the second connector of the present embodiment in a meshed state.

FIG. 3 is a cross-sectional view of the first connector and the second connector according to the present Embodiment, where FIG. 3A is a sectional view taken along the line A-A of FIG. 2 and FIG. 3B is a figure illustrating only the first connector of FIG. 3A.

FIG. 4 is a first perspective view illustrating the first connector according to the present Embodiment.

FIG. 5 is a first exploded perspective view of the first connector according to the present Embodiment.

FIG. 6 is a second perspective view illustrating the first connector according to the present Embodiment.

FIG. 7 is a second exploded perspective view of the first connector according to the present Embodiment.

FIG. 8 includes third and fourth perspective views illustrating the first connector of the present Embodiment, where FIG. 8A is a third perspective view and FIG. 8B is a fourth perspective view.

FIG. 9 is a first partial cross-sectional perspective view of the first connector according to the present Embodiment.

FIG. 10 is a second partial cross-sectional perspective view of the first connector according to the present Embodiment.

FIG. 11 is a third partial cross-sectional perspective view of the first connector according to the present Embodiment.

FIG. 12 is a perspective view illustrating a signal terminal of the first connector according to the present Embodiment.

FIG. 13 is a first perspective view illustrating an arrangement state of the signal terminals of the first connector according to the present Embodiment, where FIG. 13 A is a first perspective view and FIG. 13B is an exploded view of part B in FIG. 13A.

FIG. 14 is a second perspective view illustrating an arrangement state of the signal terminals of the first connector according to the present Embodiment, where FIG. 14A is a second perspective view and FIG. 14B is an exploded view of part C in FIG. 14A.

FIG. 15 is a perspective view illustrating an arrangement state of the first signal terminals of the first connector in the present Embodiment.

FIG. 16 is a perspective view illustrating the second connector according to the present Embodiment.

FIG. 17 is an exploded perspective view of the second connector according to the present embodiment.

FIG. 18 is a partial plan view illustrating a pitch conversion section of a terminal for a conventional connector.

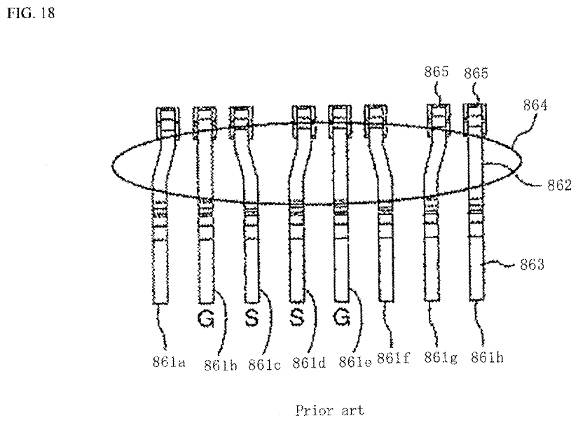

### DETAILED DESCRIPTION OF THE PREFERRED EMBODIMENTS

Embodiments will hereinafter be described in detail with reference to the drawings.

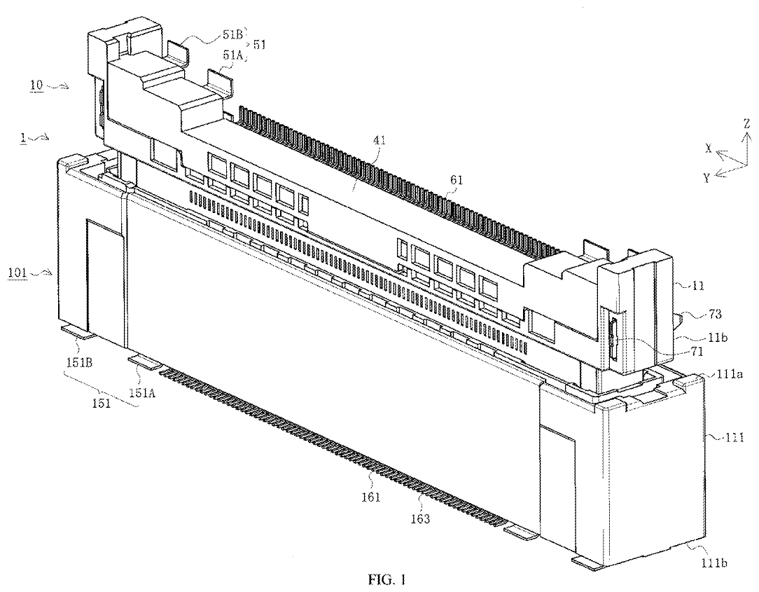

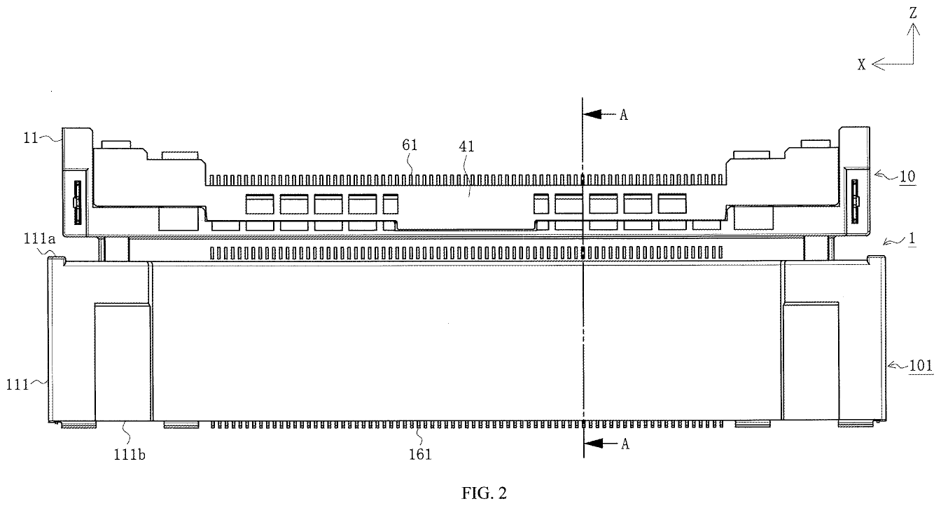

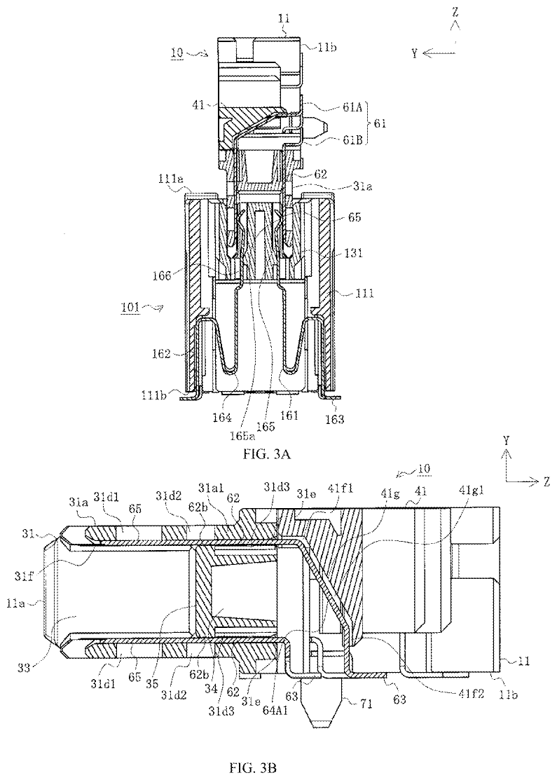

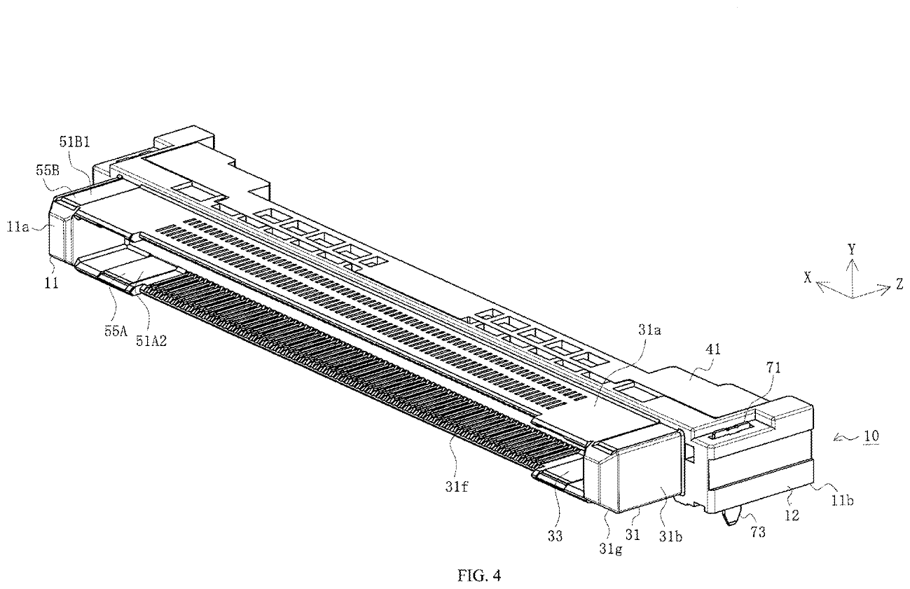

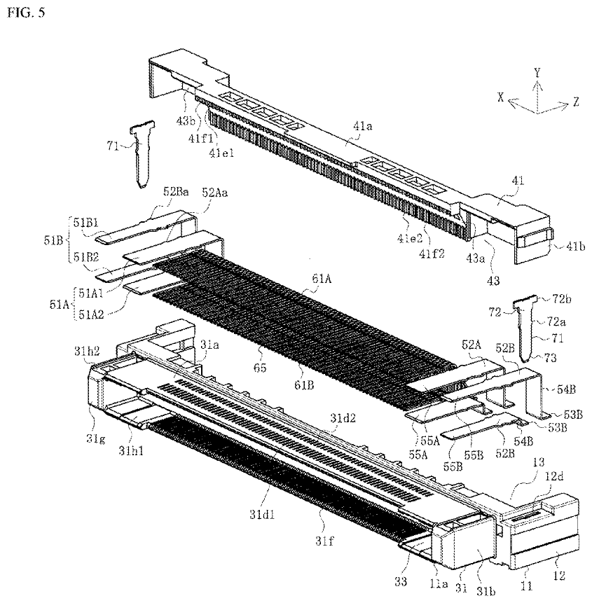

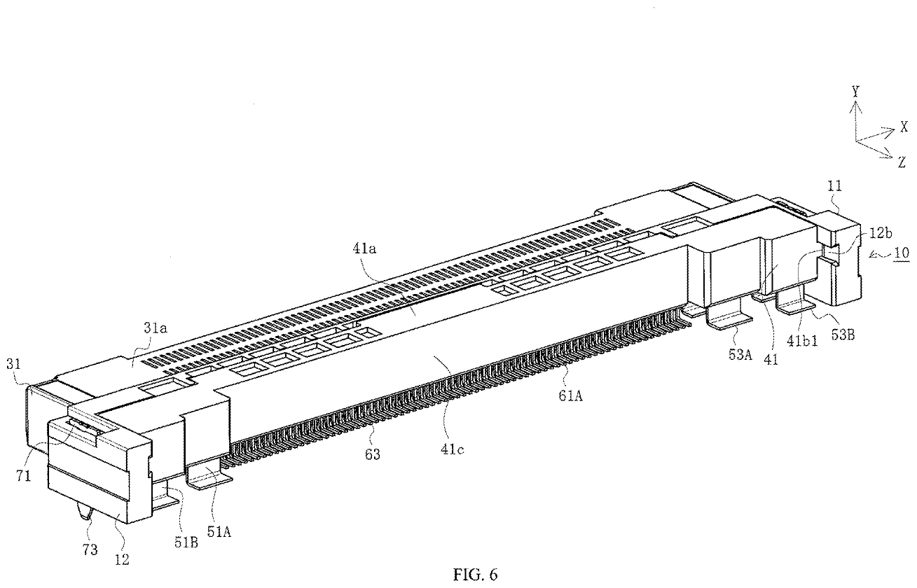

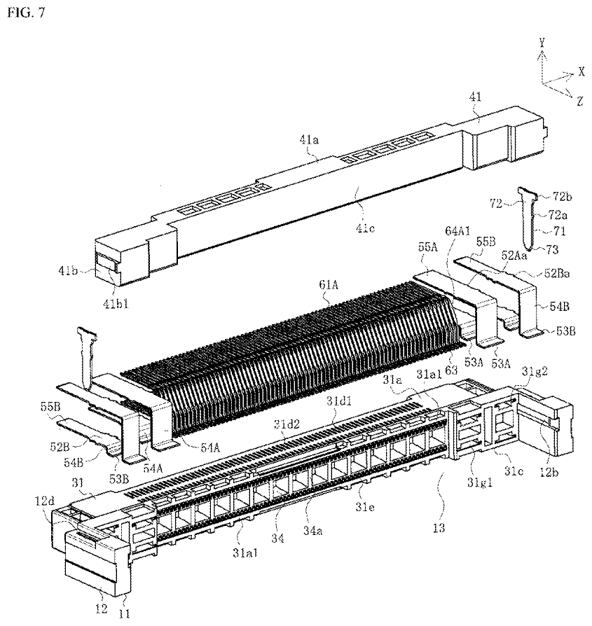

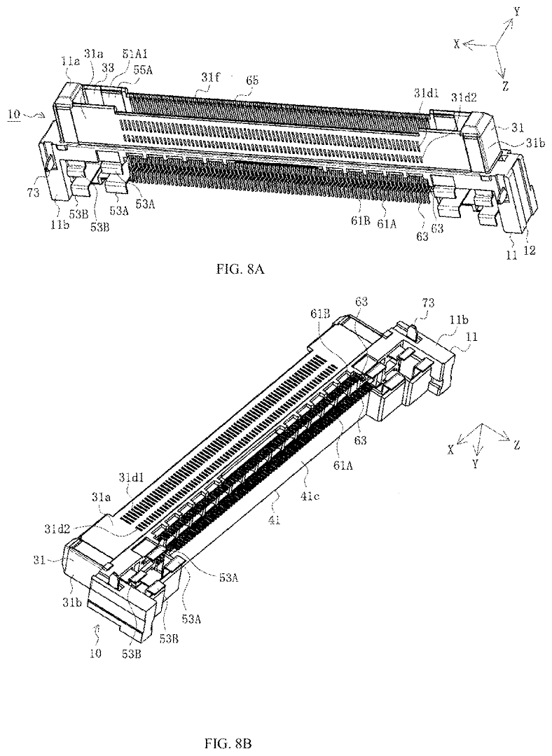

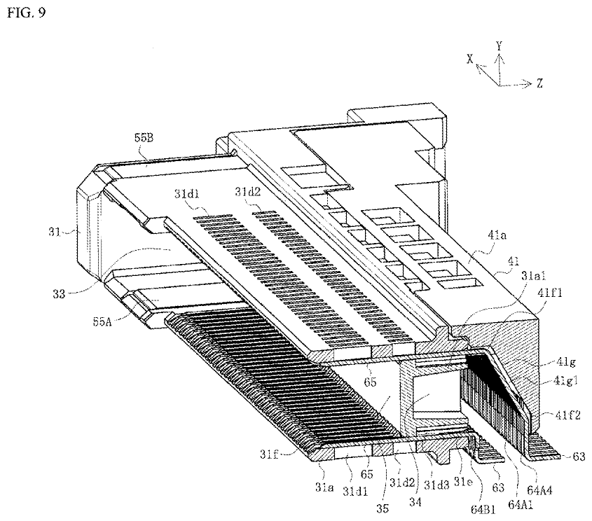

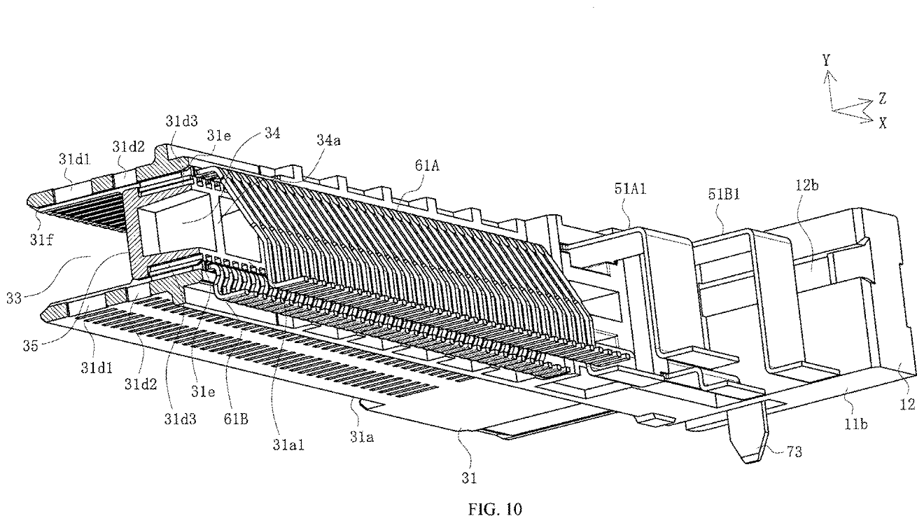

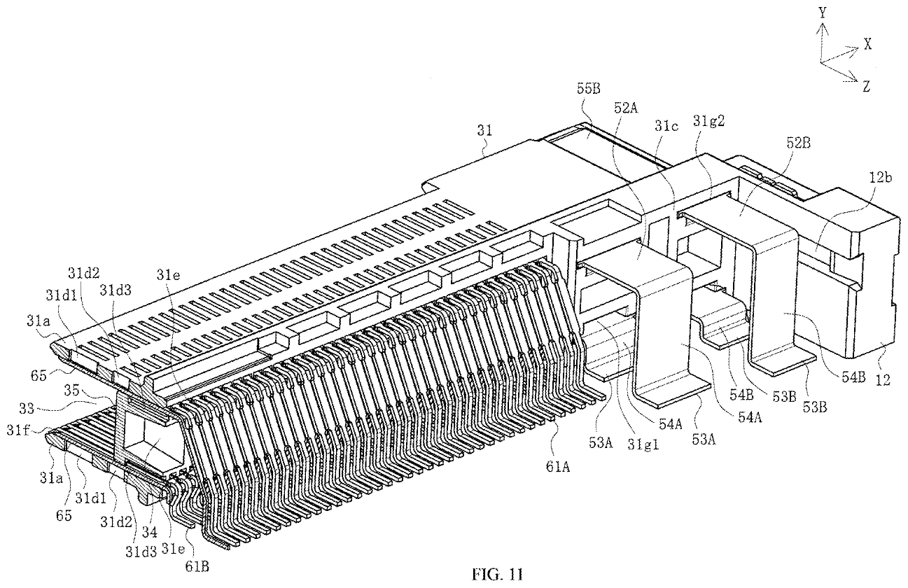

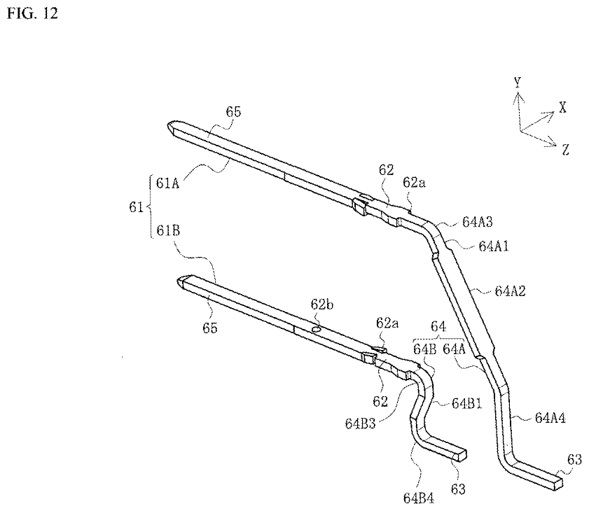

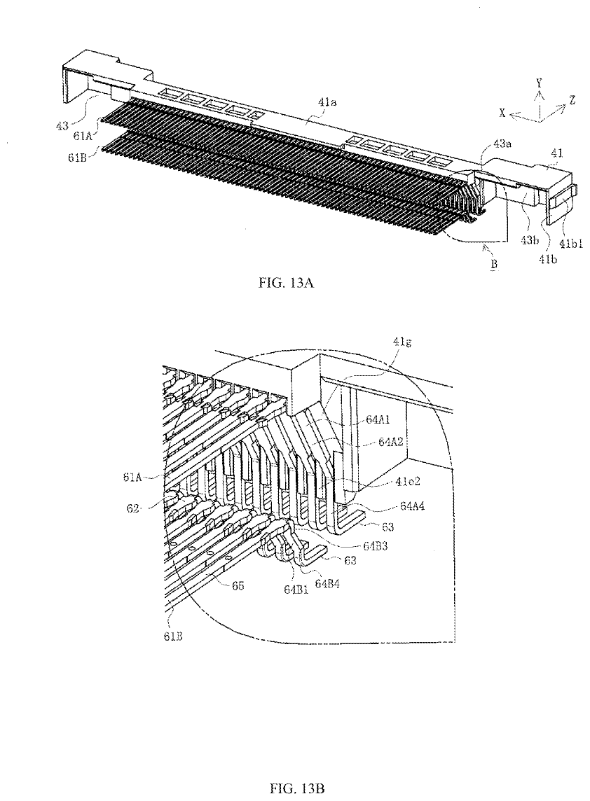

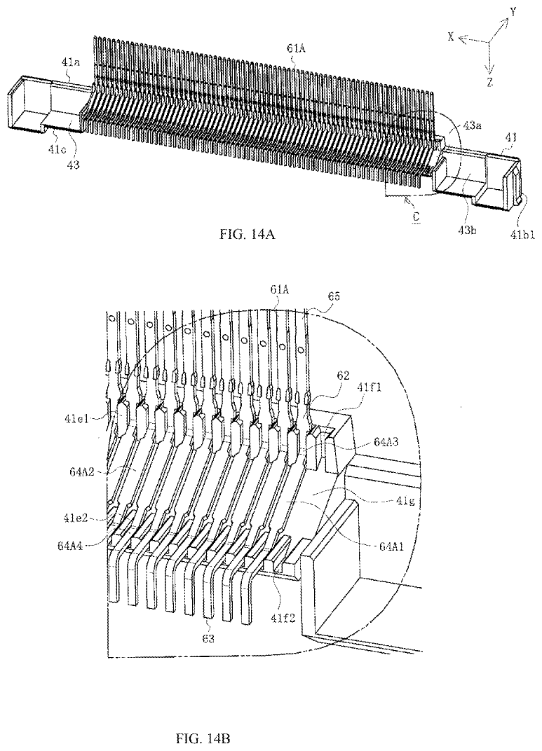

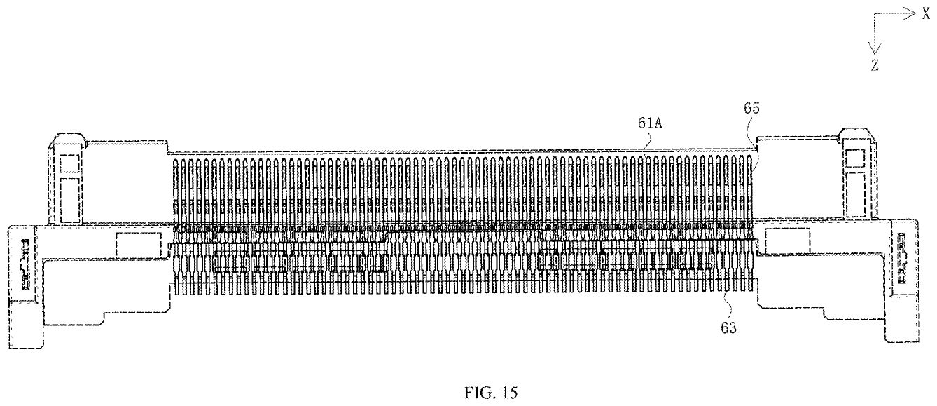

FIG. 1 is a perspective view illustrating the first connector and the second connector of the present embodiment in a meshed state. FIG. 2 is a front view illustrating the first connector and the second connector of the present embodiment in a meshed state. FIG. 3 is a cross-sectional view of the first connector and the second connector according to the present Embodiment. FIG. 4 is a first perspective view of the first connector according to the present Embodiment. FIG. 5 is a first exploded perspective view of the first connector according to the present Embodiment. FIG. 6 is a second perspective view of the first connector according to the present Embodiment. FIG. 7 is a second exploded perspective view of the first connector according to the present Embodiment. FIG. 8 includes third and fourth perspective views of the first connector according to the present Embodiment. FIG. 9 is a first partial cross-sectional perspective view of the first connector according to the present Embodiment. FIG. 10 is a second partial cross-sectional perspective view of the first connector according to the present Embodiment. FIG. 11 is a third partial cross-sectional perspective view of the first connector according to the present Embodiment. FIG. 12 is a perspective view illustrating a signal terminal of the first connector according to the present Embodiment. FIG. 13 is a first perspective view illustrating an arrangement state of the signal terminals of the first connector in the present Embodiment. FIG. 14 is a second perspective view illustrating an arrangement state of the signal terminals of the first connector in the present Embodiment. FIG. 15 is a perspective view illustrating an arrangement state of the first signal terminals of the first connector in the present Embodiment.

Note that in FIG. 3, (a) is a cross-sectional view taken along the line A-A of FIG. 2 and (b) is a figure illustrating only the first connector of (a). In FIG. 8, (a) is a third perspective view and (b) is a fourth perspective view. In FIG. 13, (a) is a first perspective view and (b) is an exploded view of the B part of (a). In FIG. 14, (a) is a second perspective view and (b) is an exploded view of the C part of (a).

In the figures, 10 is a first connector as one of a pair of board-to-board connectors 1, which are connectors in the present Embodiment. The first connector 10 is a plug connector as a board connector mounted on the surface of a first board that is a board as a mounting member (not shown) and mates with a second connector 101 as a counterpart connector. In the example illustrated in the figures, the first connector 10 is a so-called right-angle type. When mating with the second connector 101, the direction of movement relative to the second connector 101 is parallel to the surface of the board and, accordingly, the mating surface 11a of the first connector 10 first housing 11 is perpendicular to the mounting surface 11b. Note that the first connector 10 does not necessarily need to be a right angle type and may be a so-called straight type where the direction of relative movement with the second connector 101 when mating with the second connector 101 is perpendicular to the surface of the first board and the mating surface 11a of the first housing 11 is parallel to the mounting surface 11b. However, for convenience of description, the case of a right angle type will be described.

On the other hand, the second connector 101 is the other of the board-to-board connector 1 and is a receptacle connector as a board connector mounted on the surface of a second board that is a board (not shown) as a mounting member. In addition, the second connector 101 is a so-called floating type connector, and includes a second fixed housing 111 as a fixed housing fixedly attached to a surface of the second board, and a second movable housing 131 as a movable housing movable with respect to the second fixed housing 111. Furthermore, the second connector 101 is a so-called straight type where the mating surface 111a of the second fixed housing 111 is parallel with the mounting surface 111b.

Furthermore, of the counterpart terminals the second connector 101 is provided with, each of the counterpart signal terminals 161 is a long and narrow rod shaped member integrally formed by performing processing such as punching and bending an electrically conductive metal plate that provides the plate elasticity, and as illustrated in FIG. 3(a), includes a fixed side retained section 162 retained in the second fixed housing 111, a tail section 163 as a board connecting part that is connected to the end of the fixed side retained section 162 on the mounting surface 111b side, a movable side retained section 166 retained in the second movable housing 131, and a contact part 165 connected to the end of the movable side retained section 166 on the mating surface 111a side. Note that a contact protruding section 165a that swells to the outside of the second movable housing 131 in the width direction is formed on the contact part 165. In addition, each of the counterpart signal terminals 161 connect with the fixed side retained sections 162 and movable side retained sections 166 and include a bent section 164 bent in a meandering manner. The bent section 164 functions as an elastic deformation section that absorbs displacement of the second movable housing 131 relative to the second fixed housing 111.

In addition, of the counterpart terminals the second connector 101 is provided with, the power supply terminals, in other words, the counterpart power supply terminals 151 that are power supply terminals also include elastically deformable sections, and these sections absorb displacement of the second movable housing 131 relative to the second fixed housing 111. In the example illustrated in the figure, the counterpart power supply terminals 151 include first counterpart power supply terminals 151A and second counterpart power supply terminals 151B but when collectively describing the first counterpart power supply terminals 151A and the second counterpart power supply terminals 151B, they are described as counterpart power supply terminals 151.

Note that the first connector 10 is not a so-called floating type connector, and includes only a first housing 11 as a housing that is a fixed housing fixedly attached to a surface of the first board, and does not include a movable housing that is able to move.

Note that the first connector 10 and the second connector 101 of the connector pair according to the present embodiment are preferably used to electrically connect the first board to the second board but can also be used to electrically connect other members. For example, the first substrate and the second substrate are each a printed circuit board, a flexible flat cable (FFC), a flexible circuit board (FPC), or the like as used in electronic devices or the like, but may be any type of substrate.

Note, in the present embodiment, expressions indicating direction such as up, down, left, right, front, rear, and the like used to describe a configuration and operation of each part of the connector pair first connector 10 and the second connector 101 are relative rather than absolute and are appropriate when each part of the first connector 10 and the second connector 101 are in positions illustrated in the drawings. However, these directions should be interpreted as changing in accordance with a change in position when the position thereof is changed.

The first connector 10 is configured to be left-right symmetrical when viewed from the width direction (Y axis direction) and is also configured to be left-right symmetrical when viewed from the direction of movement relative to the second connector 101, in other words, the mating direction (Z axis direction). Furthermore, the first housing 11 of the first connector 10 is a member that is integrally formed using an insulating material (insulative body) such as synthetic resin. In addition, a cover 41 is attached to the first connector 10 in the mating direction on the end of the side opposite the mating side (Z axis positive direction end). This cover 41 is also a member that is integrally formed of an insulating material such as synthetic resin. Note that the cover 41 is not necessarily a required member and can be omitted. In particular if the first connector 10 is a straight type, the cover 41 is considered to be unnecessary but here, the first connector 10 is described with the cover 41 included.

The first housing 11 includes a main body section 31 and a side section 12 connected at both ends of the main body section 31 in the longitudinal direction (X axis direction) and extends in the anti-mating direction (Z axis positive direction). One of the surfaces of the side section 12 in the width direction (Y axis negative direction side) of the first connector 10 functions as a mounting surface 11b facing the surface of the first board.

The main body section 31 is a substantially square tubular member and includes a pair of rectangular flat plate long wall sections 31a that extend in the longitudinal direction and are mutually parallel; short wall sections 31b that are a pair of rectangular thick plate to polygonal column members that extend in the width direction, are mutually parallel, and connect to both ends of the long wall sections 31a; and a mating cavity 33 that is demarcated by the four surfaces of the long wall sections 31a and the short wall sections 31b, is a polygonal column cavity open at the end in the mating direction end (Z axis negative direction end), and is a recess in which a portion of the second connector 101 is stowed. In addition, a protruding end section 31g with a substantially quadrangular trapezoid shape is formed at the ends in the mating direction of the short wall sections 31b, respectively. Note that the anti-mating direction end (Z axis positive direction end) of the mating cavity 33 is closed by a bottom plate 35.

In addition, on the opposite side of the bottom plate 35, in other words, on the anti-mating direction side, an opposing cavity 34 that is a polygonal column shaped cavity is formed open at the end in the anti-mating direction end. In the example illustrated in the figure, while there is one mating cavity 33, there are a plurality of opposing cavities 34. Each of the opposing cavities 34 is demarcated by four polygonal column surfaces including partition walls 34a with adjacent opposing cavities 34 and thick sections 31a1 of the long wall sections 31a. Herein, the main body section 31 can prevent occurrence of distortion or deformation that may occur during manufacturing steps or during use. In addition, this ensures strength of the main body section 31 and enables achieving size reduction. The thick sections 31a1 are sections that are further in the mating direction of the long wall sections 31a than the bottom plate 35 and sections where the inner surface of the long wall sections 31a, in other words, the inner surface of the main body section 31 in the width direction (Y axis direction) is formed thick so as to be positioned towards the center of the main body section 31 in the width direction.

Furthermore, a board connection space 13 that is a space demarcated on three sides by the pair of side sections 12 and the anti-mating side surface 31c of the main body section 31 is formed on the anti-mating direction side of the main body section 31. The board connecting part of each terminal and cover 41 provided on the first connector 10 are stowed in this board connection space 13.

In addition, metal fitting retention recesses 12d are formed in each of the side sections 12 and housing fixation metal fittings 71 are stowed and retained inside these metal fitting retention recesses 12d. The housing fixation metal fitting 71 is a member that is integrally formed and provided elasticity by performing punching and bending on a metal plate and as illustrated in FIGS. 5 and 7, includes a retained section 72, and a tip section 73 as a board connecting section connected to the lower end of the retained section 72. The retained section 72 is formed with a first retention protruding section 72a that bites into the inner surface of the metal fitting retention recess 12d and a second retention protruding section 72b. In addition, the tip section 73 protrudes from the mounting surface 11b of the first housing 11, is inserted into a retaining hole formed on the first board, and desirably being combined with a connecting means such as soldering, is firmly connected to the first board. Note that the housing fixation metal fitting 71 can be omitted if not needed. Note that a boss (protruding part for aligning) that protrudes from the first housing 11 or a hole for alignment may be provided on the case, chassis, or fixing plate of the first housing 11 that is attached to the first connector 10 to align the first connector 10.

As illustrated in FIG. 12, the signal terminals 61 that are signal terminals provided on the first connector 10 are long narrow rod shaped members integrally formed by performing processing such as punching and bending on a conductive metal plate, provided elasticity, and include a retained section 62, a tail section 63 as a board connecting part, a connecting section 64, and a contact part 65. In the example illustrated in the figure, the signal terminal 61 includes a first signal terminal 61A and a second signal terminal 61B. The retained section 62 and contact part 65 of the first signal terminal 61A are arranged so as to be in a location further separated from the mounting surface 11b of the first housing 11 than the retained section 62 and contact part 65 of the second signal terminal 61B. Note that in the case where the first signal terminal 61A and second signal terminal 61B are collectively described, they are described as signal terminal 61.

The individual first signal terminals 61A and second signal terminals 61B are members with a structure as illustrated in FIG. 12, and a plurality of first signal terminals 61A and a plurality of second signal terminals 61B are respectively arranged in a single row, lined up in the width direction of the first connector 10 with, for example, an approximately 0.5 [mm] pitch. Note that the number and pitch values of the first signal terminals 61A and second signal terminals 61B can be suitably set but here the first signal terminals 61A and second signal terminals 61B will be described as having the same number and the same pitch and as being arranged such that the contact parts 65 of each of the first signal terminals 61A and the contact parts 65 of each of the second signal terminals 61B overlap when viewed from the width direction (Y axis direction) of the first connector 10.

The signal terminals 61 are used for transmitting signals and in recent years, the speed of various signals has increased; therefore, use for transmitting high frequency signals of, for example, 5 to 40 [GHz] is anticipated. In the case of transmitting this manner of high frequency signals, there is demand for matching impedances. Therefore, in the present Embodiment, the impedance of the signal terminals 61 is adjustable.

On the signal terminal 61, the retained section 62 is a section that extends in the mating direction (Z axis direction) and a plurality of engaging protrusions 62a are formed on the surface thereof. The engaging protrusions 62a bite into the first housing 11; therefore, the retained section 62 engages with and is retained to the first housing 11. Note that a pressing protrusion 62b is formed on the surface of the retained section 62 facing the center side in the width direction of the first connector 10. In addition, the contact part 65 is a thick plate to square bar shape section that extends from the tip, in other words, mating direction end (Z axis negative direction end) of the retained section 62 in a straight line in the mating direction (Z axis negative direction) and the contact protruding section 165a of the contact part 165 of the counterpart signal terminal 161 contacts the surface thereof. Furthermore, the tail section 63 is a thick plate to square bar shape portion that extends from the lower end of the connecting section 64, in other words, a first end (Y axis negative direction end) of the first connector 10 in the width direction, in a straight line in the anti-mating direction (Z axis positive direction) and is secured to a connection pad formed on the surface of the first board (not shown) by means of soldering or the like. This connection pad is typically connected to a conductive trace for transmitting signals on the first board.

The plurality of signal terminals 61, in other words, the first signal terminals 61A and second signal terminals 61B are generally, in other words except for the connecting sections 64, arranged so as to form at least two mutually parallel rows. The connecting section 64 is called the first connecting section 64A in the first signal terminal 61A and the second connecting section 64B in the second signal terminal 61B.

The first connecting section 64A includes an inclined section 64A1 that is inclined relative to the mating direction (Z axis direction) and extends in a straight line; a lower connecting section 64A4 that extends from the lower end of the inclined section 64A1, in other words, from a first end (Y axis negative direction end) in the width direction of the first connector 10 in a straight line in the width direction of the first connector 10 and is connected with the tail section 63; and an upper connecting section 64A3 that bends from the upper end of the inclined section 64A1, in other words, from a second end (Y axis positive direction end) in the width direction of the first connector 10, and is connected to the rear end of the retained section 62, in other words, the anti-mating direction end (Z axis positive direction end). Therefore, as illustrated in FIG. 3(b), as viewed from the longitudinal direction (X axis direction) of the first connector 10, the first signal terminal 61A has an overall crank shape but with the upper corner of the upper part of the crank short-cut by the inclined section 64A1. Furthermore, a broad section 64A2 with a dimension in the width direction (Y axis direction) larger than other sections of the first connecting section 64A is formed on the inclined section 64A1. Making the size of the broad section 64A2 be adjustable enables making the impedance of the first signal terminal 61A adjustable. Note that the dimensions of the other sections of the first connecting section 64A are the same as those of the tail section 63 and are formed smaller than the contact part 65 and the retained section 62. Furthermore, when viewed from the width direction (Y axis direction) of the first connector 10, as illustrated in FIG. 15, the first signal terminal 61A extends in a straight line from the tip of the contact part 65, in other words from the mating direction end (Z axis negative direction end) to the rear end of the tail section 63 (Z axis positive direction end) in the mating direction.

In addition, as illustrated in FIG. 3(b), as viewed from the longitudinal direction (X axis direction) of the first connector 10, the second signal terminal 61B has a substantially crank shape with the corner of the crank being short-cut. The second connecting section 64B extends in a direction orthogonal to the mating direction and includes an inclined section 64B1 inclined relative to the width direction of the first connector 10; a lower connecting section 64B4 that is bent from the lower end of the inclined section 64B1, in other words, from a first end (Y axis negative direction end) in the width direction of the first connector 10, and is connected to the tail section 63; and an upper connecting section 64B3 that is bent from the upper end of the inclined section 64B1, in other words from a second end (Y axis positive direction end) in the width direction of the first connector 10, and is connected to the rear end, in other words the anti-mating direction end (Z axis positive direction end) of the retained section 62. The overall width direction dimension of the second connecting section 64B is formed constant, the same as that of the tail section 63, and smaller than the contact part 65 and retained section 62. Furthermore, when viewed from the mating direction (Z axis direction), the inclined section 64B1 is inclined such that the lower end thereof deviates (is offset) half the pitch towards one end (X axis negative direction end) in the longitudinal direction of the first connector 10 more than the upper end.

Therefore, the tail section 63 of the second signal terminal 61B deviates toward one end (X axis negative direction end) in the longitudinal direction of the first connector 10 by half the pitch more than the tail section 63 of the corresponding first signal terminal 61A. Therefore, when viewed from the width direction (Y axis direction) of the first connector 10, the contact parts 65 of the first signal terminals 61A and second signal terminals 61B overlap; however, the tail sections 63 are arranged staggered by half the pitch in the longitudinal direction of the first connector 10. Thus, the connection pads the tail sections 63 of the first signal terminals 61A connect to and the connection pads the tail sections 63 of the second signal terminals 61B connect to are arranged staggered by half the pitch in the longitudinal direction of the first connector 10 on the surface of the first board so even if the value of the pitch is small, connection operations such as the soldering of the tail sections 63 can easily be performed and the routing of the conductive traces that connect to the connection pads is also easy.

Furthermore, the signal terminals 61 are mounted to the first housing 11 by the contact parts 65 and the retained sections 62 being inserted into signal terminal stowing recesses 31e are formed so as to be open from the anti-mating side surface 31c side of the first housing 11 main body section 31 to the anti-mating side surface 31c. As illustrated in FIG. 7, the openings of the signal terminal stowing recesses 31e are arranged lined up to form a signal row in the longitudinal direction (X axis direction) of the first connector 10 on the thick sections 31a1 of the long wall section 31a at a first end (Y axis negative direction end side) in the width direction of the first connector 10 and the thick section 31a1 of the long wall section 31a on a second end (Y axis positive direction end side) in the width direction of the first connector 10. First, the contact part 65 and retained section 62 of the second signal terminal 61B are inserted into the lower side, in other words, into the signal terminal stowing recess 31e that is open on a first end (Y axis negative direction end side) in the width direction of the first connector 10 and thus, the second signal terminal 61B is mounted to the first housing 11. Then, the contact part 65 and retained section 62 of the first signal terminal 61A is inserted into the upper side, in other words, into the signal terminal stowing recess 31e that is open on a second end (Y axis positive direction end side) in the width direction of the first connector 10 and thus, the first signal terminal 61A is mounted to the first housing 11.

Thereby, the first signal terminal 61A and second signal terminal 61B are mounted to the first housing 11 in the form as illustrated in FIGS. 3 and 9 to 11. Contact part stowing grooves 31f extending in the mating direction (Z axis direction) are formed on the surfaces on the mating cavity 33 side of each long wall section 31a at positions corresponding to each of the signal terminal stowing recesses 31e and are arranged lined up to form a single row in the longitudinal direction (X axis direction) of the first connector 10. Furthermore, mutually corresponding signal terminal stowing recesses 31e and contact part stowing grooves 31f communicate with each other, passing through the bottom plate 35 that is the partition wall of the opposing cavity 34 and mating cavity 33.

In addition, a first space portion 31d1 and second space portion 31d2 that are long narrow slit shape spaces are formed in the long wall sections 31a extending in the mating direction (Z axis direction) as spaces that pass through the long wall sections 31a in the thickness direction and are positioned corresponding to each of the contact part stowing grooves 31f on the long wall sections 31a on both sides of the mating cavity 33. The first space portion 31d1 and second space portion 31d2 are mutually separated in the mating direction. Furthermore, the side surfaces of the signal terminals 61 that are the side surfaces of the long wall sections 31a side or the first side surface are exposed to the outside of the first connector 10 through the first space portions 31d1 and second space portions 31d2. Note that with the signal terminals 61, the side surfaces exposed to the outside of the first connector 10 through the first space portions 31d1 and second space portions 31d2 can be gold plated if necessary to improve corrosion resistance. In addition, the portion of the signal terminals 61 corresponding to the first space portions 31d1 with regards to the mating direction are portions that can function as areas that contact the counterpart signal terminals 161.

Note that the dimension of the first space portions 31d1 in the mating direction are desirably set larger than that of the second space portions 31d2. In addition, with regards to the mating direction, the area of the second space portions 31d2 desirably overlaps with the area of the bottom plate 35 with the mating direction end (Z axis negative direction end) of the second space portions 31d2 being positioned further in the mating direction than that of the bottom plate 35 and the anti-mating direction end (Z axis positive direction end) of the second space portions 31d2 being positioned further in the anti-mating direction side than that of the bottom plate 35. Furthermore, the dimensions of the first space portions 31d1 and second space portions 31d2 in the width direction (Y axis direction) are desirably set smaller than the retained sections 62 and contact parts 65 of the signal terminals 61. The first space portions 31d1 and second space portions 31d2 are spaces formed in the first housing 11 that is an insulative body and the sizes thereof can be suitably set. Thus, the dielectric constant of the insulative body surrounding the periphery of the signal terminals 61 can be adjusted, enabling adjusting the impedance of the signal terminals 61.

Furthermore, the signal terminal stowing recesses 31e are locations that engage with and retain the retained sections 62 of the signal terminals 61 and the cross-sectional area thereof is larger than that of the retained sections 62 of the signal terminals 61 and third space portions 31d3 are formed in a portion of the retained sections 62 on the opposing cavities 34 side. In other words, third space portions 31d3 are formed on a second side surface (side surface on the side opposite the long wall sections 31a) of the signal terminals 61. In addition, as the third space portions 31d3 are integrally formed with the signal terminal stowing recesses 31e, the retained sections 62 of the signal terminals 61 are engaged and retained in the third space portions 31d3.

Similar to the first space portions 31d1 and second space portions 31d2, the third space portions 31d3 are spaces formed in the first housing 11 that is an insulative body and the sizes thereof can be suitably set. Thus, the dielectric constant of the insulative body surrounding the periphery of the signal terminals 61 can be adjusted, enabling adjusting the impedance of the signal terminals 61. Note that with regards to the mating direction, the area of the third space portions 31d3 desirably overlaps with the area of the second space portions 31d2 with the mating direction end (Z axis negative direction end) of the third space portions 31d3 positioned further to the mating direction side than the anti-mating direction end (Z axis positive direction end) of the second space portions 31d2.

On the lower side, the retained sections 62 of the second signal terminals 61B inserted into the signal terminal stowing recesses 31e of a first end (Y axis negative direction end side) in the width direction of the first connector 10 are reliably retained in the signal terminal stowing recesses 31e by the engaging protrusions 62a biting into the wall surface of the signal terminal stowing recesses 31e. The contact parts 65 are stowed in the contact part stowing grooves 31f and the upper side thereof, in other words, the surfaces on a second end (Y axis positive direction end side) in the width direction of the first connector 10 are exposed in the mating cavity 33. Note that the pressing protrusion 62b of the retained section 62 pushes on the bottom plate 35 and based on the reaction force thereof, the contact part 65 is pressed against the bottom surface of the contact part stowing groove 31f, preventing springing from the contact stowing groove 31f into the mating cavity 33. Furthermore, portions of the lower surface of the contact part 65 face the first space portion 31d1 and second space portion 31d2. In addition, the surface on the upper side of the retained section 62 faces the third space portion 31d3. Furthermore, the tail section 63 of the second signal terminal 61B is positioned below (Y axis negative direction) the lower long wall section 31a and is at nearly the same position as the mounting surface 11b of the first housing 11.

In addition, on the upper side, the retained sections 62 of the first signal terminals 61A inserted into the signal terminal stowing recesses 31e of a second end (Y axis positive direction end side) in the width direction of the first connector 10 are reliably retained in the signal terminal stowing recesses 31e by the engaging protrusions 62a biting into the wall surface of the signal terminal stowing recesses 31e. The contact parts 65 are stowed in the contact part stowing grooves 31f and the lower side thereof, in other words, the surfaces on a first end (Y axis negative direction end side) in the width direction of the first connector 10 are exposed in the mating cavity 33. Note that the pressing protrusion 62b of the retained section 62 pushes on the bottom plate 35 and based on the reaction force thereof, the contact part 65 is pressed against the bottom surface of the contact part stowing groove 31f, preventing springing from the contact stowing groove 31f into the mating cavity 33. Furthermore, portions of the upper surface of the contact part 65 face the first space portion 31d1 and second space portion 31d2. In addition, the surface on the lower side of the retained section 62 faces the third space portion 31d3. Furthermore, the tail sections 63 of the first signal terminals 61A are positioned more in the anti-mating direction (Z axis positive direction) than the tail sections 63 of the second signal terminal 61B as well as below (Y axis negative direction) the lower long wall section 31a and are at nearly the same position as the mounting surface 11b of the first housing 11.

The power supply terminals 51 of the counterpart terminals that the first connector 10 is provided with that are power supply terminals and are long narrow band shaped members integrally formed by performing processing such as punching and bending on a conductive metal plate, providing them with elasticity. In the example illustrated in the figure, the power supply terminals 51 include first power supply terminals 51A and second power supply terminals 51B. Further, the first power supply terminals 51A include 11th power supply terminals 51A1 and 12th power supply terminals 51A2 and the second power supply terminals 51B include 21st power supply terminals 51B1 and 22nd power supply terminals 51B2. The second power supply terminals 51B are arranged more to the outside of the first housing 11 in the longitudinal direction (X axis direction) of the main body section 31 than the first power supply terminals 51A.

In this manner, in the example illustrated in the figure, the power supply terminals 51 that the first connector 10 is provided with is four pairs of terminals enabling positive and negative electric current to flow and conduct through contact with corresponding counterpart power supply terminals 151 of the second connector 101 but are not necessarily limited to four pairs and three pairs or less may be used or four pairs or more may be used. Note that when described collectively, the 11th power supply terminals 51A1 and 12th power supply terminals 51A2 are described as first power supply terminals 51A. Also, when described collectively, the 21st power supply terminals 51B1 and 22nd power supply terminals 51B2 are described as second power supply terminals 51B. When described collectively, the first power supply terminals 51A and second power supply terminals 51B are described as power supply terminals 51.

As illustrated in FIGS. 5 and 7, the 11th power supply terminals 51A1 and 12th power supply terminals 51A2 respectively include a retained section 52A, a tail section 53A as a board connecting part, connecting section 54A, and contact part 55A. The dimension of the 11th power supply terminals 51A1 and 12th power supply terminals 51A2 in the width direction (X axis direction) is constant along the entire length and is the same for both.

With the 11th power supply terminals 51A1 and 12th power supply terminals 51A2, the retained section 52A is a portion extending in the mating direction (Z axis direction) and a plurality of engaging protrusions 52Aa are formed on the surface thereof. The retained section 52A engages with and is retained in the first housing 11 by the engaging protrusions 52Aa biting into the first housing 11. In addition, the contact part 55A is a flat portion extending from the end of the retained section 52A, in other words, from the mating direction end (Z axis negative direction end) in a straight line in the mating direction (Z axis negative direction) and a counterpart power supply terminal 151 contacts the surface thereof. Furthermore, the tail section 53A is a portion extending from the lower end of the connecting section 54A, in other words, from a first end (Y axis negative direction end) in the width direction of the first connector 10 in a straight line in the anti-mating direction (Z axis positive direction) and is connected and secured to a connection pad formed on the surface of the first board (not shown) by means of soldering or the like. This connection pad is typically connected to a conductive trace for transmitting power on the first board.

In addition, the connecting section 54A of the 11th power supply terminals 51A1 is set longer than the connecting section 54A of the 12th power supply terminals 51A2 and thereby, the retained section 52A and contact part 55A of the 11th power supply terminals 51A1 are arranged at a portion more separated from the mounting surface 11b of the first housing 11 than the retained section 52A and contact part 55A of the 12th power supply terminals 51A2.

Furthermore, the retained section 52A of the 11th power supply terminals 51A1 is set longer than the retained section 52A of the 12th power supply terminals 51A2, and thereby the connecting section 54A and the tail section 53A of the 11th power supply terminals 51A1 are arranged at a location further from the mating surface 11a of the first housing 11 than the connecting section 54A and the tail section 53A of the 12th power supply terminals 51A2.

As illustrated in FIGS. 5 and 7, the 21st power supply terminals 51B1 and 22nd power supply terminals 51B2 respectively include a retained section 52B, a tail section 53B as a board connecting part, connecting section 54B, and contact part 55B. The dimension of the 21st power supply terminals 51B1 and 22nd power supply terminals 51B2 in the width direction (X axis direction) is constant along the entire length and is the same for both. Note that in the example illustrated in the figure, the dimensions of the 21st power supply terminals 51B1 and the 22nd power supply terminals 51B2 in the width direction (X axis direction) are smaller than that of the 11th power supply terminals 51A1 and the 12th power supply terminals 51A2.

With the 21st power supply terminals 51B1 and 22nd power supply terminals 51B2, the retained section 52B is a portion extending in the mating direction (Z axis direction) and a plurality of engaging protrusions 52Ba are formed on the surface thereof. The retained section 52B engages with and is retained in the first housing 11 by the engaging protrusions 52Ba biting into the first housing 11. In addition, the contact part 55B is a flat portion extending from the end of the retained section 52B, in other words, from the mating direction end (Z axis negative direction end) in a straight line in the mating direction (Z axis negative direction) and a counterpart power supply terminal 151 contacts the surface thereof. Furthermore, the tail section 53B is a portion extending from the lower end of the connecting section 54B, in other words, from a first end (Y axis negative direction end) in the width direction of the first connector 10 in a straight line in the anti-mating direction (Z axis positive direction) and is connected and secured to a connection pad formed on the surface of the first board (not shown) by means of soldering or the like. This connection pad is typically connected to a conductive trace for transmitting power on the first board.

In addition, the connecting section 54B of the 21st power supply terminals 51B1 is set longer than the connecting section 54B of the 22nd power supply terminals 51B2 and thereby, the retained section 52B and contact part 55B of the 21st power supply terminals 51B1 are arranged at a location further from the mounting surface 11b of the first housing 11 than the retained section 52B and contact part 55B of the 22nd power supply terminals 51B2.

Furthermore, the retained section 52B of the 21st power supply terminals 51B1 is set longer than the retained section 52B of the 22nd power supply terminals 51B2, and thereby the connecting section 54B and tail section 53B of the 21st power supply terminals 51B1 are arranged at a location further from the mounting surface 11a of the first housing 11 than the connecting section 54B and tail section 53B of the 22nd power supply terminals 51B2.

Furthermore, the first power supply terminals 51A are mounted to the first housing 11 by the contact parts 55A and the retained section 52A being inserted into a first power supply terminal stowing recess 31g1 is formed so as to be open from the anti-mating side surface 31c side of the first housing 11 main body section 31 to the anti-mating side surface 31c. As illustrated in FIG. 7, on the outside of both ends of the row of openings of the signal terminal stowing recesses 31e, there is one opening of the first power supply terminal stowing recess 31g1 both at a first end (Y axis negative direction end side) in the width direction and at a second end (Y axis positive direction end side) in the width direction of the first connector 10. First, the contact part 55A and retained section 52A of the 12th power supply terminals 51A2 are inserted into the lower side, in other words, into the first power supply terminal stowing recess 31g1 open on a first end (Y axis negative direction end side) in the width direction of the first connector 10, and thereby the 12th power supply terminals 51A2 are mounted to the first housing 11. Thereafter, the contact part 55A and retained section 52A of the 11th power supply terminals 51A1 are inserted into the upper side, in other words, into the first power supply terminal stowing recess 31g1 open on a second end (Y axis positive direction end side) of the first connector 10 in the width direction, thereby the 11th power supply terminals 51A1 are mounted to the first housing 11.

Thus, in the aspect illustrated in FIGS. 4, 6, and 8, the first power supply terminals 51A are mounted in the first housing 11. Contact part stowing grooves 31h1 extending in the mating direction (Z axis direction) are formed on the mating cavity 33 side surfaces of each of the long wall sections 31a to the outside of the rows of contact part stowing grooves 31f at a position corresponding to each of the first power supply terminal stowing recesses 31g1. Furthermore, mutually corresponding first power supply terminal stowing recesses 31g1 and contact part stowing grooves 31h1 communicate with each other. Therefore, the upper sides, in other words, the surfaces on the mating cavity 33 side of the long wall section 31a on the second end side (Y axis positive direction end side) in the width direction of the first connector 10, of the contact part 55A of the 11th power supply terminals 51A1 mounted to the first housing 11 are exposed. Also, the lower sides, in other words, the surfaces on the mating cavity 33 side of the long wall section 31a on the first end side (Y axis negative direction end side) in the width direction of the first connector 10, of the contact part 55A of the 12th power supply terminals 51A2 mounted to the first housing 11 are exposed.

In addition, the second power supply terminals 51B are mounted to the first housing 11 by the contact parts 55B and retained section 52B being inserted into a second power supply terminal storing recess 31g2 is formed so as to be open from the anti-mating side surface 31c side of the first housing 11 main body section 31 to the anti-mating side surface 31c. As illustrated in FIG. 7, the openings of the second power supply terminal storing recesses 31g2 are arranged to the outside of the openings of the first power supply terminal stowing recesses 31g1 respectively on a first end (Y axis negative direction end side) in the width direction and a second end (Y axis positive direction end side) in the width direction of the first connector 10 with regards to the longitudinal direction (X axis direction) of the first connector 10. First, the contact part 55B and retained section 52B of the 22nd power supply terminals 51B2 are inserted into the second power supply terminal storing recesses 31g2 open on the lower side, in other words, into a first end (Y axis negative direction end side) in the width direction of the first connector 10, and thereby mounting the 22nd power supply terminals 51B2 to the first housing 11. Subsequently, the contact part 55B and retained section 52B of the 21st power supply terminals 51B1 are inserted into the second power supply terminal storing recesses 31g2 open on the upper side, in other words, into a second end (Y axis positive direction end side) in the width direction of the first connector 10, and thereby the 21st power supply terminals 51B1 are mounted to the first housing 11.

Thus, in the aspect illustrated in FIGS. 4, 6, and 8, the second power supply terminals 51B are mounted in the first housing 11. Contact part stowing grooves 31h2 extending in the mating direction (Z axis direction) are formed on the outer surface of each short wall section 31b at both ends (Y axis positive and negative direction end sides) in the width direction of the first connector 10 in a position corresponding to each of the second power supply terminal storing recesses 31g2. Furthermore, mutually corresponding second power supply terminal storing recesses 31g2 and contact part stowing grooves 31h2 communicate with each other. Therefore, the contact parts 55B of the 21st power supply terminals 51B1 mounted in the first housing 11 are exposed on the outer surface of the upper side of the short wall sections 31b, in other words, on the second end (Y axis positive direction end side) in the width direction of the first connector 10 and the contact parts 55B of the 22nd power supply terminals 51B2 mounted to the first housing 11 are exposed on the outer surface of the lower side of the short wall sections 31b, in other words, on the first end (Y axis negative direction end side) in the width direction of the first connector 10.

In this manner, after the signal terminals 61 and power supply terminals 51 are mounted to the first housing 11, the cover 41 is mounted to the first housing 11. The cover 41 is an elongated box shape member that includes a rectangular flat plate shape upper wall section 41a extending in the longitudinal direction (X axis direction) of the main body section 31, a pair of side wall sections 41b extending in the longitudinal direction (Y axis direction) of the main body section 31 connected to both ends of the upper wall section 41a, and a rear wall section 41c that extends in the longitudinal direction (X axis direction) of the main body section 31 and that is orthogonal to the upper wall section 41a and the side wall sections 41b. Furthermore, a terminal stowing space 43 is formed on the inside of the box shaped cover 41, the periphery thereof demarcated by the upper wall section 41a, the side wall sections 41b, and the rear wall section 41c. This terminal stowing space 43 is a space with the surfaces on the mating direction side (Z axis positive direction side) and the first housing 11 mounting surface 11b side (Y axis negative direction side) open. Furthermore, the terminal stowing space 43 includes an elongated signal terminal corresponding section 43a that extends in the longitudinal direction (X axis direction) of the main body section 31 and, with respect to the longitudinal direction of the main body section 31, power supply corresponding sections 43b positioned at both ends of the signal terminal corresponding section 43a.

In addition, engaging protrusion sections 41b1 are formed on the outer surface of the side wall sections 41b. The engaging protrusion sections 41b1 are able to engage with engaging recesses 12b formed on the surfaces of the side sections 12 of the first housing 11 facing inward in the longitudinal direction (X axis direction) of the main body section 31. Furthermore, with the signal terminals 61 and power supply terminals 51 mounted, the cover 41 is moved relative to the first housing 11 from the anti-mating side surface 31c side of the main body section 31 toward the mating surface 11a side and each of the engaging protrusion sections 41b1 is inserted into the corresponding engaging recesses 12b, thereby engaging, and is thus stowed on the board connection space 13 of the main body section 31. Thereby, as illustrated in FIG. 6, a large portion of the connecting sections 64 and tail sections 63 of the signal terminals 61 are stowed inside the signal terminal corresponding section 43a and covered by the cover 41 and a large portion of the connecting sections 54A and tail sections 53A of the first power supply terminals 51A and connecting sections 54B and tail sections 53B of the second power supply terminals 51B are stowed inside the power supply corresponding sections 43b and covered by the cover 41, preventing foreign material such as dust from adhering.

A plurality of upper ribs 41e1 that protrude downward, in other words, in a direction towards the mounting surface 11b are formed lined up in the longitudinal direction of the main body section 31 on the inner surface of the upper wall section 41a inside the signal terminal corresponding section 43a. Furthermore, the spaces between adjacent upper ribs 41e1 function as upper connecting section stowing grooves 41f1 for stowing the upper connecting sections 64A3 of the first signal terminals 61A.

In addition, a plurality of lower ribs 41e2 that protrude forward, in other words, in a direction toward the mating surface 11a are formed lined up in the longitudinal direction of the main body section 31 on the inner surface of the rear wall section 41c inside the signal terminal corresponding section 43a. Furthermore, the spaces between adjacent lower ribs 41e2 function as lower connecting section stowing grooves 41f2 for stowing the lower connecting sections 64A4 of the first signal terminals 61A.

Furthermore, an inclined plane 41g is formed inside the signal terminal corresponding section 43a between the inner surface of the upper wall section 41a and the inner surface of the rear wall section 41c. The inclined plane 41g is set to be parallel with the inclined sections 64A1 of the first signal terminals 61A when the cover 41 is mounted to the first housing 11. Furthermore, as illustrated in FIG. 3(b), an inclined space section 41g1 is formed between the inclined plane 41g and the inclined sections 64A1. The size of the inclined space section 41g1 can be appropriately set and thereby, the dielectric constant of the dielectric body surrounding the periphery of the first signal terminals 61A can be adjusted, enabling adjusting the impedance of the first signal terminals 61A.

Note that ribs similar to the upper ribs 41e1 or lower ribs 41e2 are not formed on the inclined plane 41g. In other words, ribs are not formed between the upper ribs 41e1 and the lower ribs 41e2. In addition, with the first signal terminals 61A, the upper connecting sections 64A3 are stowed and retained in the upper connecting section stowing grooves 41f1 between the upper ribs 41e1 and the lower connecting sections 64A4 are stowed and retained in the lower connecting section stowing grooves 41f2 between the lower ribs 41e2, thereby positioning the inclined sections 64A1 in the width direction thereof, and reliably preventing contact of mutually adjacent broad sections 64A2.

Next, the configuration of the second connector 101 will be described.

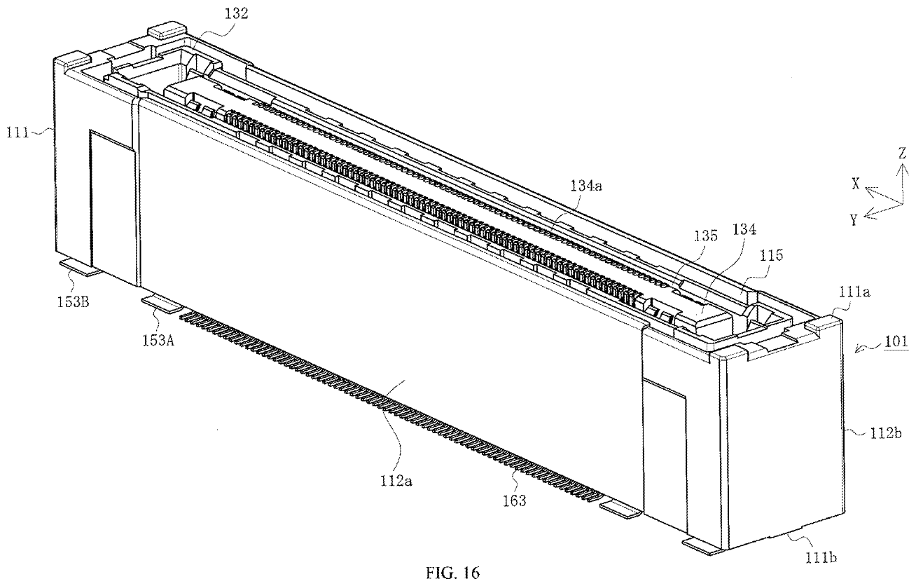

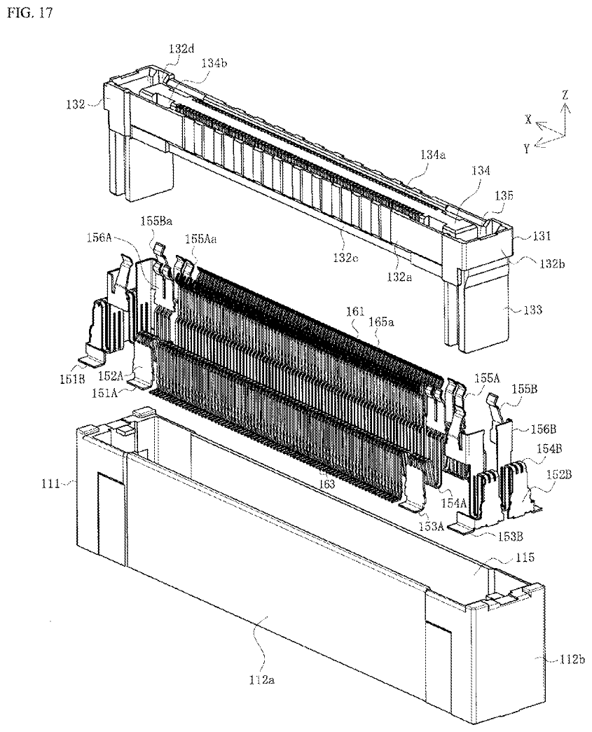

FIG. 16 is a perspective view illustrating the second connector of the present embodiment. FIG. 17 is an exploded perspective view of the second connector of the present embodiment.

In the present embodiment, the second connector 101 is configured so as to be left-right symmetrical when viewed in the width direction (Y-axis direction), and is also configured to be left-right symmetrical when viewed in the longitudinal direction (X-axis direction). Furthermore, the second fixed housing 111 and the second movable housing 131 of the second connector 101 are each members integrally formed by an insulator (insulative body) such as a synthetic resin.

The second fixed housing 111 is a substantially square tubular member, and includes a pair of rectangular flat plate-shaped long wall sections 112a that are mutually parallel extending in the longitudinal direction of the second connector 101; short wall sections 112b that are a pair of mutually parallel rectangular thick plate members extending in the width direction of the second connector 101, are shorter than the long wall sections 112a, and are connected to the end parts of the long wall sections 112a in the longitudinal direction; and a movable housing cavity for stowing 115 that is a polygonal column shaped cavity open on the upper and lower ends (Z axis direction both ends) demarcated by the long wall sections 112a and short wall sections 112b. The lower surface of the second fixed housing 111 is a mounting surface 111b facing the surface of the second board. Furthermore, a signal terminal mounting section and first power supply terminal mounting section (not shown) are formed on the surface, in other words, the inside surface, of the movable housing cavity for stowing 115 on the lower end (Z axis negative direction end) of each long wall section 112a. Also, a second power supply terminal mounting section (not shown) is formed on the inner surface of the lower side of each short wall section 112b.

The fixed side retained sections 162 of the counterpart signal terminals 161 are retained in the signal terminal mounting sections. In addition, fixed side retained sections 152A of the first counterpart power supply terminals 151A are retained in the first power supply terminal mounting section and fixed side retained sections 152B of the second counterpart power supply terminals 151B are retained in the second power supply terminal mounting section.

Each of the first counterpart power supply terminals 151A are members integrally formed and provided elasticity by performing processing such as punching and bending on conductive metal plates and include a fixed side retained section 152A, a tail section 153A connected to a lower end of the fixed side retained section 152A as a board connecting part, a bent section 154A connected to the upper end of the fixed side retained section 152A, a movable side retained section 156A connected to the upper end of the bent section 154A, and a contact part 155A connected to the movable side retained section 156A. Note that a contact protruding section 155Aa that swells to the outside of the second movable housing 131 in the width direction is formed on the contact part 155A. The bent section 154A bends in a meandering manner, functioning as an elastic deformation section and this absorbs displacement of the second movable housing 131 relative to the second fixed housing 111.

In addition, each of the second counterpart power supply terminals 151B are members integrally formed and provided elasticity by performing processing such as punching and bending on conductive metal plates and include a fixed side retained section 152B, a tail section 153B connected to a lower end of the fixed side retained section 152B as a board connecting part, a bent section 154B connected to the upper end of the fixed side retained section 152B, a movable side retained section 156B connected to the upper end of the bent section 154B, and a contact part 155B connected to the movable side retained section 156B. Note that the contact part 155B is bent at nearly a right angle relative to the movable side retained section 156B and connected thereto. In addition, a contact protruding section 155Ba that swells to the inside of the second movable housing 131 in the width direction is formed on the contact part 155B. The bent section 154B bends in a meandering manner, functioning as an elastic deformation section and this absorbs displacement of the second movable housing 131 relative to the second fixed housing 111.

The second movable housing 131 includes a substantially trough shaped main body section 132 and a pair of leg sections 133 extending downward from the lower ends at both ends of the main body section 132 in the longitudinal direction of the second connector 101. The main body section 132 includes a pair of rectangular thick plate-shaped long wall sections 132a that are mutually parallel and extend in the longitudinal direction of the second connector 101; short wall sections 132b that are a pair of mutually parallel rectangular thick plate members extending in the width direction of the second connector 101, are shorter than the long wall sections 132a, and are connected to the ends of the long wall sections 132a in the longitudinal direction; a first housing cavity for stowing 135 that is a polygonal column shaped cavity demarcated by the four surfaces of the long wall sections 132a and short wall sections 132b and is open on the upper end (Z axis positive direction end); and a bottom section 132c that is connected to the lower ends of the long wall sections 132a and the lower ends of the short wall sections 132b and blocks the lower end (Z axis negative direction end) of the first housing cavity for stowing 135.

With the first connector 10 and second connector 101 in a mated state, at least a part of the main body section 31 in the first housing 11 of the first connector 10 is stowed inside the first housing cavity for stowing 135 Furthermore, a thick plate shaped central wall section 134 extending in the longitudinal direction of the second connector 101 is arranged inside the first housing cavity for stowing 135. The central wall section 134 is a member extending upward from the upper surface of the bottom section 132c and is formed such that the outer peripheral surface thereof is separated from the inner surface of the long wall sections 132a and the inner surface of the short wall sections 132b. Furthermore, a plurality of signal terminal contact section stowing grooves 134a are formed on both side surfaces of the central wall section 134. In addition, a signal terminal movable side retention recess that extends in the vertical direction and penetrates from a lower surface to an upper surface of the bottom section 132c is formed in a location corresponding to each signal terminal contact section stowing groove 134a of the bottom section 132c. The contact parts 165 of the counterpart signal terminals 161 and the movable side retained sections 166 are respectively stowed and retained in the signal terminal contact section stowing grooves 134a that extend in the vertical direction and in the signal terminal movable side retention recess connected thereto.

Furthermore, first power supply terminal movable side stowing recesses 134b are formed on both side surfaces of the central wall section 134 closer to the ends thereof than the signal terminal contact section stowing grooves 134a. In addition, first power supply terminal movable side retention recesses that extend in the vertical direction and penetrate from the bottom surface to the top surface of the bottom section 132c are formed in locations corresponding to the first power supply terminal movable side stowing recesses 134b of the bottom section 132c. The contact parts 155A of the first counterpart power supply terminals 151A and the movable side retained section 156A are respectively stowed and retained in the first power supply terminal movable side stowing recesses 134b that extend in the vertical direction and the first power supply terminal movable side retention recesses connected thereto.

Furthermore, the second power supply terminal movable side stowing recesses 132d are formed on the inner surfaces of the long wall sections 132a at both ends in the longitudinal direction and the contact parts 155B of the second counterpart power supply terminals 151B are stowed in these second power supply terminal movable side stowing recesses 132d.

Next, the operation of mating the first connector 10 and the second connector 101 with the above configuration is described.

Here, the first connector 10 is mounted on the surface of the first board by connecting the tail sections 63 of the signal terminals 61 and the tail sections 53A and 53B of the power supply terminals 51 to connection pads on the surface of the first board (not shown) by means of soldering. In addition, connection pads connected to the tail sections 63 of the signal terminals 61 are connected to conductive traces for transmitting signals on the first board and connection pads connected to the tail sections 53A and 53B of the power supply terminals 51 are connected to conductive traces for transmitting power supply on the first board. Furthermore, a cover 41 is attached to the first housing 11.

In a similar manner, the second connector 101 is mounted on the surface of the second board by connecting the tail sections 163 of the counterpart signal terminals 161 and the tail sections 153A and 153B of the counterpart power supply terminals 151 to connection pads on the surface of the second board (not shown) by means of soldering. In addition, connection pads connected to the tail sections 163 of the counterpart signal terminals 161 are connected to conductive traces for transmitting signals on the second board and connection pads connected to the tail sections 153A and 153B of the counterpart power supply terminals 151 are connected to conductive traces for transmitting power supply on the second board.

First, the operator sets the mating surface 11a of the first housing 11 for the first connector 10 and the mating surface 111a of the second fixed housing 111 for the second connector 101 facing each other and makes adjustments so the position of the main body section 31 of the first housing 11 for the first connector 10 aligns with the position of the first housing cavity for stowing 135 of the second movable housing 131 for the second connector 101. This completes positioning of the first connector 10 and the second connector 101.

In this state, as the first connector 10 and/or the second connector 101 are moved in a direction closer to the counterpart side, in other words, in a mating direction, the main body section 31 of the first housing 11 is inserted into the first housing cavity for stowing 135 of the second movable housing 131 such that the central wall section 134 in the first housing cavity for stowing 135 is inserted into and stowed in the mating cavity 33 of the main body section 31. Note that substantially quadrangular trapezoid shape protruding end sections 31g having inclined surfaces are formed at the mating direction end of the main body section 31 short wall sections 31b such that upon mating, the main body section 31 is smoothly inserted into the first housing cavity for stowing 135.

Thus, as illustrated in FIGS. 1, 2, and 3(a), with the first connector 10 and second connector 101 in a mated state, the first housing 11 mates with the second movable housing 131, at least a part of the first space portions 31d1 formed on the long wall sections 31a of the first housing 11 are covered by the second connector 101, corresponding signal terminals 61 and counterpart signal terminals 161 are caused to conduct, and corresponding power supply terminals 51 and counterpart power supply terminals 151 are caused to conduct.

Specifically, at least a part of the main body section 31 of the first housing 11 near the mating end advances into the first housing cavity for stowing 135 and at least a part of the first space portions 31d1 formed on the long wall sections 31a of the main body section 31 are covered by the long wall sections 132a of the second movable housing 131. In addition, the surface of the contact parts 65 of the signal terminals 61 stowed in the contact part stowing grooves 31f of the long wall sections 31a to the center of the first connector 10 in the width direction function as contact areas and come into contact with the contact protruding sections 165a of the counterpart signal terminals 161 contact parts 165 stowed in the signal terminal contact section stowing grooves 134a of the central wall section 134 inside the first housing cavity for stowing 135. Thus, the signal terminals 61 and the counterpart signal terminals 161 are electrically connected. Here, the contact parts 165 of the counterpart signal terminals 161 function as a cantilever and the contact protruding sections 165a are pushed onto the surface of the contact parts 65 of the signal terminals 61 based on the elasticity exhibited by this cantilever so electrical connection of the signal terminals 61 and the counterpart signal terminals 161 is reliably maintained.

In addition, the contact protruding sections 155Aa of the contact parts 155A of the first counterpart power supply terminals 151A stowed in the first power supply terminal movable side stowing recesses 134b on both side surfaces of the central wall section 134 come into contact with the contact parts 55A of the first power supply terminals 51A exposed on the inner surface of the mating cavity 33. Also, the contact protruding sections 155Ba of the contact parts 155B of the second counterpart power supply terminals 151B stowed in the second power supply terminal movable side stowing recesses 132d on the inner surface of the long wall sections 132a come into contact with the contact parts 55B of the second power supply terminals 51B exposed on the outer surface of the short wall sections 31b. Thus, the power supply terminals 51 and counterpart power supply terminals 151 are electrically connected. Herein, the contact parts 155A of the first counterpart power supply terminals 151A function as a cantilever and the contact protruding sections 155Aa are pushed onto the contact surface of the contact parts 55A of the first power supply terminals 51A based on the elasticity exhibited by this cantilever. Also, the contact parts 155B of the second counterpart power supply terminals 151B function as a cantilever and the contact protruding sections 155Ba are pushed onto the contact surface of the contact parts 55B of the second power supply terminals 51B by the elasticity exhibited by this cantilever. Therefore, the electrical connection state of the power supply terminals 51 and the counterpart power supply terminals 151 is reliably maintained.

In this manner, with the present Embodiment, the first connector 10 is provided with the first housing 11 and the signal terminals 61 attached in the first housing 11. Furthermore, the first housing 11 includes the first space portions 31d1 and second space portions 31d2 positioned further in the anti-mating direction than the first space portions 31d1. One side surface of the signal terminals 61 is exposed to the outside of the first connector 10 through the first space portions 31d1 and the second space portions 31d2 and the first housing 11 further includes third space portions 31d3. The third space portions 31d3 are positioned on the other side surface of the signal terminals 61 and the signal terminals 61 engage with the third space portions 31d3.

Thus, the impedance of the signal terminals 61 can be appropriately adjusted. In addition, this enables size reduction of the first connector 10 along with simplifying the structure, reducing component count, simplification of manufacturing, reducing cost, and improving reliability.

In addition, the dimensions of the first space portions 31d1 in the mating direction are larger than those of the second space portions 31d2. Furthermore, with the first connector 10 and the second connector 101 in a mated state, at least a part of the first space portions 31d1 is covered by the second connector 101. Furthermore, the first housing 11 includes a mating cavity 33 that is open at the mating direction end that is a recessed section for stowing at least a portion of the second connector 101, long wall sections 31a that demarcate at least a portion of the side surfaces of the mating cavity 33, and a bottom plate 35 that closes the anti-mating direction end of the mating cavity 33. Also, the second space portions 31d2 are formed in the long wall sections 31a and overlap with the bottom plate 35 in the mating direction. Furthermore, the second space portions 31d2 and third space portions 31d3 are formed mutually adjacent with regards to the mating direction. Furthermore, the dimensions of the first space portions 31d1 and second space portions 31d2 in the width direction are smaller than the dimension of the signal terminals 61 in the width direction. Furthermore, the portions of the signal terminals 61 corresponding to the first space portions 31d1 with regards to the mating direction can function as contact areas with the counterpart signal terminals 161 of the second connector 101. Furthermore, there are a plurality of signal terminals 61 formed mutually parallel lined up in at least two rows. The first space portions 31d1, second space portions 31d2, and third space portions 31d3 positioned on the side surface of the signal terminals 61 of each row are symmetrically formed so as to face each other. Furthermore, the side surfaces of the signal terminals 61 exposed to the outside of the first connector 10 through the first space portions 31d1 and the second space portions 31d2 can be gold plated.

Note that the disclosure herein describes features relating to suitable exemplary Embodiments. Various other Embodiments, modifications, and variations within the scope and spirit of the claims appended hereto will naturally be conceived of by those skilled in the art upon review of the disclosure herein.

The present disclosure can be applied to a board connector and to a board-to-board connector.

1. A board connector, comprising:
(a) housing; and a signal terminal mounted in this housing; wherein
(b) the housing includes a first space portion and a second space portion positioned further in the anti-mating direction than the first space portion, and a first side surface of the signal terminal is exposed to the outside of the board connector through the first space portion and the second space portion, and
(c) the housing further includes a third space portion and this third space portion is positioned on a second side surface of the signal terminal and the signal terminal engages with the third space portion.

2. The board connector according to claim 1, wherein the dimension of the first space portion in the mating direction is larger than that of the second space portion.

3. The board connector according to claim 1, wherein with the board connector and counterpart connector in a mated state, at least a part of the first space portion is covered by the counterpart connector.

4. The board connector according to claim 1, wherein the housing further includes:
a recessed section for stowing at least a portion of the counterpart connector and that is open on the mating direction end,
a long wall section that demarcates at least a portion of the side surface of the recessed section, and
a bottom plate that closes the anti-mating direction end of the recessed section, and
the second space portion is formed in the long wall section, overlapping with the bottom plate in the mating direction.

5. The board connector according to claim 1, wherein the second space portion and third space portion are formed mutually adjacent with respect to the mating direction.

6. The board connector according to claim 1, wherein the dimensions of the first space portion and the second space portion in the width direction are smaller than the dimension of the signal terminal in the width direction.

7. The board connector according to claim 1, wherein the portion of the signal terminal corresponding to the first space portion with respect to the mating direction can function as a contact area with the counterpart signal terminal of the counterpart connector.

8. The board connector according to claim 1, wherein there are a plurality of signal terminals forming at least two mutually parallel rows with the first space portion, second space portion, and third space portion positioned on the side surface of the signal terminals of each row symmetrically formed to face each other.

9. The board connector according to claim 1, wherein gold plating is performed on the side surface of the signal terminal exposed to the outside of the board connector through the first space portion and the second space portion.

10. A board-to-board connector, comprising:
the board connector according to claim 1 and a counterpart connector that mates with this board connector.
